(19) United States
(12) Patent Application Publication
(10) Pub. No.: US 2017/0077709 A1
(43) Pub. Date: Mar. 16, 2017

(54) PV SYSTEM HAVING DISTRIBUTED DC-DC CONVERTERS

(71) Applicant: ABB Technology Ltd., Zurich (CH)

(72) Inventors: Hongrae Kim, Cary, NC (US); Jing Xu, Cary, NC (US); Yu Du, Raleigh, NC (US)

(21) Appl. No.: 14/854,181

(22) Filed: Sep. 15, 2015

(51) Int. Cl. H02J 3/38; H02M 7/44; H02M 3/04

(52) U.S. Cl. CPC H02J 3/383; H02M 3/04; H02M 7/44

(57) ABSTRACT

A solar energy field having one or more solar energy assemblies is provided. The solar energy assemblies can each have a DC-DC converter which when used with a central converter maintains line voltage between the two below a regulatory threshold such as 80 Volts. The central converter can be a DC-AC converter or a DC-DC converter. Each of the DC-DC converters have or are coupled with an MPPT controller, and in some forms the DC-DC converters can include smart meter devices. Plug and play devices can be used between the DC-DC converters and the central converter. The central converter can provide power to an AC or DC grid within a dwelling such as a house.

### TECHNICAL FIELD

The present invention generally relates to photovoltaic (PV) systems, and more particularly, but not exclusively, to PV systems having distributed DC-DC converters.

### BACKGROUND

Providing improvements to PV systems to permit installation without devices such as arc fault current interrupters remains an area of interest. Some existing systems have various shortcomings relative to certain applications. Accordingly, there remains a need for further contributions in this area of technology.

### SUMMARY

One embodiment of the present invention is a unique PV system that lacks AFCI devices on a DC-DC converter. Other embodiments include apparatuses, systems, devices, hardware, methods, and combinations for maintaining system voltages within a regulatory limit without aid of AFCI devices. Further embodiments, forms, features, aspects, benefits, and advantages of the present application shall become apparent from the description and figures provided herewith.

### BRIEF DESCRIPTION OF THE FIGURES

FIG. 1 depicts an embodiment of a solar energy field.

FIG. 2 depicts an embodiment of a solar energy field connected to an AC grid.

FIG. 3 depicts an embodiment of a topology of a DC-DC converter.

FIG. 4 depicts an embodiment of a topology of a DC-DC converter.

FIG. 5 depicts an embodiment of a topology of a central converter.

FIG. 6 depicts an embodiment of a topology of a central converter.

FIG. 7 depicts an embodiment of a solar energy field connected to a DC grid.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

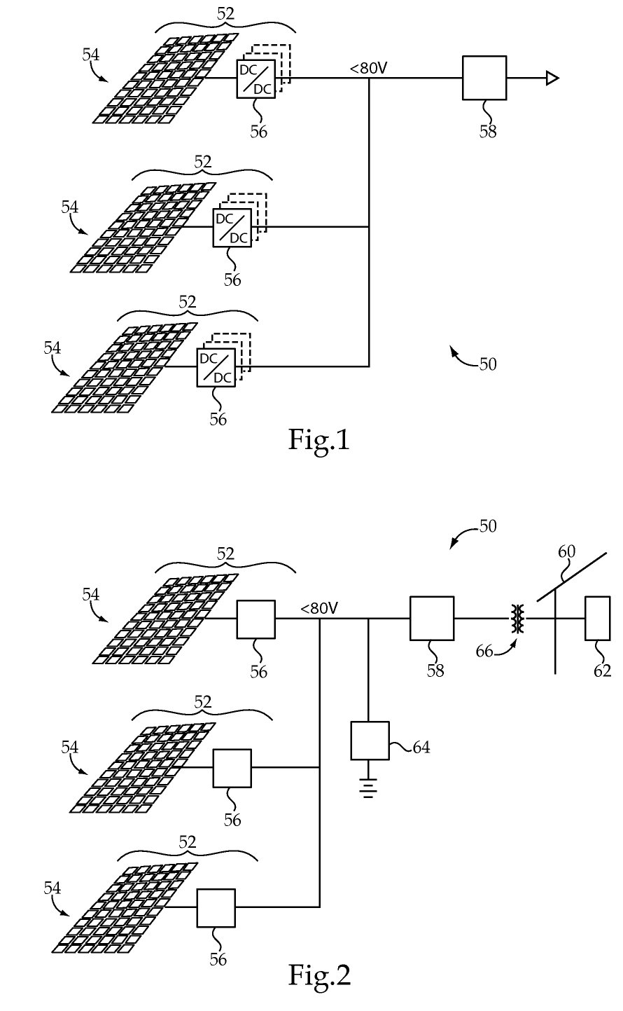

With reference to FIG. 1, a solar energy field 50 is shown having a number of solar energy assemblies 52 which together are capable of producing and/or contributing useful electric power to an alternating current (AC) or direct current (DC) grid. Each of the solar energy assemblies 52 include an array of photovoltaic (PV) cells 54 as well as a DC-DC converter 56 which can be a micro-converter as will be appreciated. The solar energy field 50 also includes a central converter 58 structured to receive power from the various solar energy assemblies 52 and provide power through a central power output to a grid.

The array of PV cells 54 act as the power producing component of the assembly wherein the individual cells can take on any variety of constructions such as but not limited to monocrystalline, polycrystalline, and thin film. The array of PV cells 54 are typically (but not necessarily always) assembled in close proximity to one another and in some forms can be coupled with a common carrier/substrate to form a unitary PV cell construction. Such a unitary construction can allow for ease of transportation, installation, and maintenance. The unitary construction can be mechanically and/or electrically connected with other unitary constructions to form the array of PV cells 54 that provide power as described above. For example, the array of PV cells 54 can take on any variety of arrangements useful for providing power to the DC-DC converter 56, such as but not limited to a solar module, solar panel, or solar array. The solar energy assembly 52 can include an arrangement of sufficient numbers of individual PV cells 54 to provide any range of power, such as power above 100 W to set forth just one non-limiting example.

In some forms any individual solar energy assembly 52 (or one or more of its constituent parts) can be hard mounted to a dwelling such as a house, apartment, business, etc via fastening techniques including mechanical, chemical, and metallurgical. To set forth just a few nonlimiting examples, the individual solar energy assemblies 52 can be fastened to a dwelling via clamps, screws, rivets, bonding agents, and welding.

The DC-DC converter 56 can be integral with a structure retaining the array of PV cells 54 in such a manner that both can be considered a unitary component and/or transported simultaneously together. In one embodiment the structure retaining the PV cells 54 can have a housing that includes electronic circuitry/components of the DC-DC converter 56. The housing itself can be integral to the structure retaining the PV cells 54, while in some forms the housing can be separately made (i.e. in one or more constituent pieces) that is then later fastened to the structure retaining the PV cells 54. Such a separately made housing can be releasably fastened to the structure such as through screws, clips, etc, to set forth just a few non-limiting examples. The separately made housing can alternatively and/or additionally be coupled to the structure through a bonding, riveting, etc process that provides a non-releasable fastening. In other embodiments the DC-DC converter 56 can be a separate component including circuitry and an appropriate housing that is thereafter fastened to the structure that retains the PV cells 54. In these embodiments the DC-DC converter 56 can be releasably and/or non-releasably fastened to the structure. The term “housing” refers generally to the contours of a device that can be handled and which generally define the structure that encloses and/or supports its constituent pieces. For example, the housing can include a chassis upon/to which various components are attached.

The DC-DC converter 56 can take on a number of forms and in general is structured to permit its input voltage to “float”, while delivering a variable current at a fixed voltage to a device and/or load. The DC-DC converter 56 can be a buck converter, boost converter, or buck-boost converter, and in some embodiments may include a transformer. As will be described in more detail below, the DC-DC converter 56 can include/be integrated or coupled with other functioning components such as a Maximum Power Point Tracker (MPPT) and/or a smart meter. The additional functioning components are shown as dashed lines in FIG. 1 to denote that those features can either be included with the DC-DC converter.

As will be appreciated, an MPPT module can be used to seek out the maximum power point of the solar energy assembly 52. In some embodiments the MPPT and DC-DC converter can be structured such that the input voltage to the DC-DC converter is regulated by the MPPT module to “float” to whatever voltage yields maximum power from the solar energy assembly 52 (in turn the DC-DC converter can be structured such that its output is at a fixed voltage but the current allowed to “float”). The MPPT can be located within the physical confines of a housing of the DC-DC converter and/or integrated or coupled to it, but the MPPT can alternatively be located elsewhere in the solar energy assembly 52. It will be appreciated that the MPPT can be implemented via digital and/or analog techniques, and can take on a variety of forms including perturb and observe, incremental conductance, current sweep, and constant voltage, to set forth just a few nonlimiting examples.

Furthermore, it will be appreciated that a smart meter can be incorporated into one or more components of the solar energy field 50, such as but not limited to the DC-DC converter 56 and/or the central converter 58. The smart meter can include one or more communications devices (transmitter, receiver, transceiver, for example) can transmit to and receive data from a central communications center, and can do so using any variety of techniques. For example, the smart meter can use cell and/or pager networks, satellite, licensed and/or unlicensed radio, and power line communication. Furthermore, the smart meter can be used in a network environment such as fixed wireless, mesh network, etc. The smart meter can be structured to communicate status information such as but not limited to power, voltage, and current. In some forms the status information can be real-time while in others can additionally and/or alternatively include historic information. The status information can be compiled through measurement and/or be calculated.

In one non-limiting embodiment, the smart meter can be integrated into the system such that the micro-converters 56 coordinate with the central converter 58. The utility and the system exchange information and requests through the communication channels.

The central converter 58 to which one or more DC-DC converters 56 are connected can take on a variety of forms. For example, the central converter 58 can be either a DC-DC converter or a DC-AC converter, non-limiting embodiments of which are shown and discussed further below. In some embodiments the central converter 58 can include a transformer. While the DC-DC converters 56 are shown as standing off from the unitary PV array 54, in some embodiments the DC-DC converters 56 can be integrated with or in closer proximity to the unitary PV array 54, no matter what the form of the central converter 58. The central converter 58 can provide real and reactive power support, dynamic VAR injection, low voltage ride through, and randomization of timing for trip and reconnection.

The central converter 58 can be connected to DC-DC converters 56 through plug and play devices. For example, a cable routed between the central converter 58 and DC-DC converter 56 can include on at least one end a connector (male or female) that incorporates plug and play features. As will be appreciated, plug and play connectors permit are unlike hardwired connections in that they permit rapid connection and disconnection, and may also provide some degree of environmental protection. The plug and play connectors can furthermore have features that permit the connector to be secured in place, such as through a clip, etc. In one embodiment a power outlet of the DC-DC converter 56 can be a fixed base terminal (male or female) structured to receive a cable having a complementary shaped connection device. In another form the DC-DC converter 56 can include a cable, for example a hardwired cable, that has a cable ending with a plug and play device (male or female) useful for connection with a complementary plug and play device associated with the central converter 58. The plug and play connection devices can thus be considered to encompass terminal side and cable ended side connections, whether those connections are male or female.

The plug and play devices can also be used in other components such as: between the array of PV cells 54 and the DC-DC converter 56; in the mechanical connection between the DC-DC converter 56 and the DC bus (which in one form is an LVDC bus); and in the mechanical connection between the DC bus and the central converter 58.

In embodiments of the instant application the connections between the DC-DC converters 56 and the central converter 58 (and for that matter any electrical connection between PV cells 54 and DC-DC converter 56) are not monitored by an arc fault current interrupter (AFCI). In light of the absence of an AFCI, it is desired to maintain the connection between the DC-DC converter 56 and the central converter 58 below a threshold amount to satisfy a regulatory requirement when the solar energy field 50 (whether including just one or multiple solar energy assemblies 52) is located in a sensitive area. In some embodiments the requirement is to maintain line voltage below a predefined threshold of 80 Volts when the solar energy assemblies 52 are located in/on a dwelling, such as but not limited to a residential roof-top installation of the solar energy assembly(ies).

Turning now to FIG. 2, a non-limiting embodiment of the solar energy field 50 is shown in which the central converter 58 is a DC-AC converter 58 connected to an AC grid within the house 60 through a connection point 62. The AC grid can be a standard 120/240 VAC. In one form the connection point 62 can be an electrical socket, such as a standard wall socket such as an AC plug, associated with the house 60. In another form the connection point 62 can be a dedicated secure AC connector which is hot swappable. The connection between the DC-AC converter 58 and the AC grid can include an AFCI and/or other electrical protective devices such as ground fault interrupters, etc. and in some forms need not constrain its voltage to the regulatory limit described above for the DC-DC converter 56 to central converter 58 connection.

Some features depicted in FIG. 2 may or may not be present in all embodiments. The battery 64 can be used to store excess power developed by the PV cells 54 but not otherwise needed or delivered to the AC grid. The battery 64 can provide ramp-up and ramp-down control of real power, grid voltage swing reduction, and back-up power. The battery 64 may not be present in all embodiments. Likewise, FIG. 2 also depicts a transformer 66 between the DC-AC converter 58 and the AC grid in the house that also may not be present in all embodiments. If a transformer is not required in the embodiment depicted in FIG. 2, an active filter can be installed to suppress common mode voltage. If a transformer is used, there are two options: (1) use of a line frequency transformer located on the output side of the central inverter 58; and (2) a high frequency transformer which can be integrated either in the micro-converters or the central inverter.

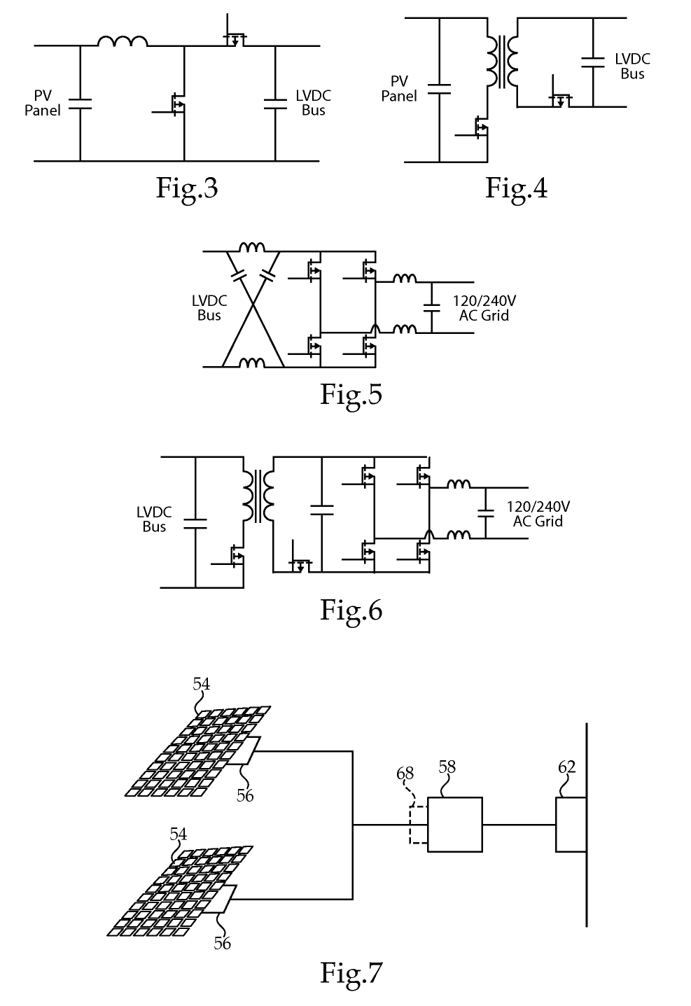

The DC-DC converter 56 can take on a variety of isolated or non-isolated forms in any of the various embodiments herein. FIG. 3 depicts a non-isolated topology in the form of a boost converter, but which depiction can include any number of variations. FIG. 4 depicts an isolated topology in the form of a flyback converter, but other variations are also contemplated such as forward converter, half bridge, full bridge, etc.

In similar fashion, the central converter 58 can also take on a variety of forms. For example, FIG. 5 depicts a non-isolated topology in the form of a Z-source inverter, and FIG. 6 depicts an isolated topology of a flyback and full-bridge inverter.

Turning now to FIG. 7, a non-limiting embodiment of the solar energy field 50 is shown in which the central converter 58 is a DC-DC converter connected to a DC grid within/on/in the house 60 through a connection point 62. The DC grid can be a low voltage DC grid (LVDC) of between 300 and 400 volts in which case the central DC-DC converter 58 is used to step up the voltage. The LVDC distribution grid can be located entirely within an area associated with dwelling, such as but limited to internal to a house, external in the curtilage of the house, etc. In some forms the LVDC distribution grid can extend to neighboring dwellings and/or out lots of the original dwelling. Such an LVDC distribution grid can be used with the dwelling in lieu of or in addition to an AC distribution grid. In some forms the LVDC distribution grid can operate between 300-400 Volts.

In some embodiments the central DC-DC converter 58 can be used to provide galvanic isolation between the PV side and the LVDC side. The central converter 58 can be structured as described above of communicating its status such as power, voltage, and current with the communication hub in the system.

A junction box 68 can optionally be used in some embodiments, and in which the plug and play connection devices described above can be used. For example, the DC cables from the DC-DC converters 56 and the DC cable from the central converter 58 can both be connected with the junction box 68.

In one form the connection point 62 can be a DC outlet that includes protection features. For example, the connection point 62 can include DC circuit interruption, DC arc fault detection/interruption, and ground fault detection/interruption. The connection point 62 can use plug and play devices as described above.

One aspect of the instant application provides an apparatus comprising a solar energy assembly having an array of photovoltaic cells each structured to convert electromagnetic radiation into an electric current, the solar energy assembly including a DC-DC converter in electrical communication with the array of photovoltaic cells and having electronic circuitry that regulates a direct current (DC) electrical output of the solar energy assembly to be less than 80V, the DC-DC converters including a communications device structured to bi-directionally communicate information with a central communications hub, the solar energy assembly also including a plug and play power outlet device of the DC-DC converter.

A feature of the present application provides wherein the communications device is a smart meter having a transceiver structured for wireless communications with the central communications hub.

Another feature of the present application provides wherein the DC-DC converter is a separate box releasably attached to a frame of the solar energy assembly, and wherein the power outlet device of the DC-DC converter is a hard mount output.

Still another feature of the present application provides wherein the DC-DC converter lacks an AFCI device, wherein the DC-DC converter includes a maximum power point tracker (MPPT).

Yet another feature of the present application further includes a central DC-DC converter to which is connected a plurality of DC-DC converters from associated solar energy assemblies.

Still yet another feature of the present application provides wherein the central DC-DC converter is the central communications hub and is in communication with a utility side data hub, wherein a junction box is located intermediate of and in electrical communication with the DC-DC converter and the central DC-DC converter, and wherein the junction box includes a plurality of plug-and-play connection devices for use with the DC-DC converter and the central DC-DC converter.

Yet still another feature of the present application further includes a DC-AC converter in electrical communication with a power output of the DC-DC converter, wherein the DC-AC converter is the central communications hub, and wherein the DC-AC converter includes an output line voltage in excess of 80 Volts.

A further feature of the present application provides wherein the DC-AC converter is in electrical communication with an AC grid, and wherein the DC-AC converter is in bi-directional information communication with a utility side grid.

Another aspect of the present application provides an apparatus comprising an array of solar energy assemblies, each assembly of the array of solar assemblies having a plurality of solar cells, an integrated DC-DC converter in electrical communication with the plurality of solar cells, and an MPPT controller configured to regulate the power output of the plurality of solar cells provided through the DC-DC converter, the DC-DC converter structured to provide direct current (DC) power at less than 80 Volts.

A feature of the present application provides wherein each assembly lacks an arc fault current interrupter (AFCI) device.

Another feature of the present application provides wherein the DC-DC converter of each assembly includes a plug and play connection device and a communications system for bi-directionally communicating information.

Yet another feature of the present application further includes a DC-AC converter in electrical communication with each assembly via the power output provided through the DC-DC converter of each assembly, the DC-AC converter located separate from the DC-DC converter of each assembly and in a location external to an area which requires voltage output of the DC-DC converter of each assembly to be less than a threshold amount when the solar energy assembly lacks an AFCI device on the output of the DC-DC converter, and wherein the DC-AC converter receives information sent by the communications system of the DC-DC converters of each assembly of the array of solar assemblies.

Still another feature of the present application provides a battery in electrical communication with the DC-AC inverter and structured to store energy for use in events such as ramp-up and ramp-down control of real power, grid voltage swing reduction, and back-up power.

Yet still another feature of the present application provides a central DC-DC converter in electrical communication with an output power of the DC-DC converter of each assembly, the central DC-DC converter being a boost converter.

Still yet another feature of the present application provides a DC outlet in direct electrical communication with the central DC-DC converter, the DC outlet having DC circuit protection including at least one of DC circuit interruption, DC arc fault detection/interruption, and ground fault detection/interruption.

A further feature of the present application provides wherein the central DC converter is located in an area that requires AFCI protection if line voltage exceeds a legally regulated amount.

Still yet a further feature of the present application provides a junction box disposed between the DC-DC converter of each assembly and the central DC-DC converter, the junction box in electrical communication with the DC-DC converter of each assembly and the central DC-DC converter via plug-and-play connection devices, and wherein the central DC-DC converter communicates information with the DC-DC converters of each assembly of the array of solar assemblies.

Yet another aspect of the present application provides a method comprising installing a plurality of solar energy assemblies each having a number of individual photovoltaic (PV) cells and a DC-DC micro-converter in electrical communication with the number of PV cells, the DC-DC micro-converter having an MPPT control device structured to request that power output of each of the plurality of solar energy assemblies remains below 80 volts, placing outputs of each of the DC-DC micro-converters in electrical communication with a central converter, the central converter constructed to provide a central converter output power, and configuring the central converter output power to be in electrical communication with a power grid.

A feature of the present application provides wherein the placing includes coupling a power line between the voltage output of the separate DC-DC micro-converters to a junction box in electrical communication with the central converter.

Another feature of the present application includes coupling a power line between the central converter output power to the power grid.

Still another feature of the present application provides wherein the central converter is a central DC-DC converter, and wherein the power grid is a low voltage direct current (LVDC) grid.

Yet still another feature of the present application provides wherein the central converter is a DC-AC converter and the power grid is a 120/240 VAC grid.

Still yet another feature of the present application includes coupling a battery to a DC bus of the plurality of solar energy assemblies.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a solar energy assembly having an array of photovoltaic cells each structured to convert electromagnetic radiation into an electric current, the solar energy assembly including a DC-DC converter in electrical communication with the array of photovoltaic cells and having electronic circuitry that regulates a direct current (DC) electrical output of the solar energy assembly to be less than a predefined threshold voltage, the DC-DC converters including a communications device structured to bi-directionally communicate information with a central communications hub, the solar energy assembly also including a plug and play power outlet device of the DC-DC converter.

2. The apparatus of claim 1, wherein the communications device is a smart meter having a transceiver structured for wireless communications with the central communications hub.

3. The apparatus of claim 2, wherein the DC-DC converter is a separate box releasably attached to a frame of the solar energy assembly, and wherein the power outlet device of the DC-DC converter is a hard mount output.

4. The apparatus of claim 2, wherein the DC-DC converter lacks an AFCI device and the predefined threshold voltage includes a regulatory threshold of 80V, and wherein the DC-DC converter includes a maximum power point tracker (MPPT).

5. The apparatus of claim 4, which further includes a central DC-DC converter to which is connected a plurality of DC-DC converters from associated solar energy assemblies.

6. The apparatus of claim 5, wherein the central DC-DC converter is the central communications hub and is in communication with a utility side data hub, wherein a junction box is located intermediate of and in electrical communication with the DC-DC converter and the central DC-DC converter, and wherein the junction box includes a plurality of plug-and-play connection devices for use with the DC-DC converter and the central DC-DC converter.

7. The apparatus of claim 4, which further includes a DC-AC converter in electrical communication with a power output of the DC-DC converter, wherein the DC-AC converter is the central communications hub, and wherein the DC-AC converter includes an output line voltage in excess of 80 Volts.

8. The apparatus of claim 7, wherein the DC-AC converter is in electrical communication with an AC grid, and wherein the DC-AC converter is in bi-directional information communication with a utility side grid.

9. An apparatus comprising:
an array of solar energy assemblies, each assembly of the array of solar assemblies having a plurality of solar cells, an integrated DC-DC converter in electrical communication with the plurality of solar cells, and an MPPT controller configured to regulate the power output of the plurality of solar cells provided through the DC-DC converter, the DC-DC converter structured to provide direct current (DC) power at less than 80 Volts.

10. The apparatus of claim 9, wherein each assembly lacks an arc fault current interrupter (AFCI) device.

11. The apparatus of claim 10, wherein the DC-DC converter of each assembly includes a plug and play connection device and a communications system for bi-directionally communicating information.

12. The apparatus of claim 11, which further includes a DC-AC converter in electrical communication with each assembly via the power output provided through the DC-DC converter of each assembly, the DC-AC converter located separate from the DC-DC converter of each assembly and in a location external to an area which requires voltage output of the DC-DC converter of each assembly to be less than a threshold amount when the solar energy assembly lacks an AFCI device on the output of the DC-DC converter, and wherein the DC-AC converter receives information sent by the communications system of the DC-DC converters of each assembly of the array of solar assemblies.

13. The apparatus of claim 12, which further includes a battery in electrical communication with the DC-AC inverter and structured to store energy for use in events such as ramp-up and ramp-down control of real power, grid voltage swing reduction, and back-up power.

14. The apparatus of claim 10, which further includes a central DC-DC converter in electrical communication with an output power of the DC-DC converter of each assembly, the central DC-DC converter being a boost converter.

15. The apparatus of claim 14, which further includes a DC outlet in direct electrical communication with the central DC-DC converter, the DC outlet having DC circuit protection including at least one of DC circuit interruption, DC arc fault detection/interruption, and ground fault detection/interruption.

16. The apparatus of claim 15, wherein the central DC converter is located in an area that requires AFCI protection if line voltage exceeds a legally regulated amount.

17. The apparatus of claim 15, which further includes a junction box disposed between the DC-DC converter of each assembly and the central DC-DC converter, the junction box in electrical communication with the DC-DC converter of each assembly and the central DC-DC converter via plug-and-play connection devices, and wherein the central DC-DC converter communicates information with the DC-DC converters of each assembly of the array of solar assemblies.

18. A method comprising:
installing a plurality of solar energy assemblies each having a number of individual photovoltaic (PV) cells and a DC-DC micro-converter in electrical communication with the number of PV cells, the DC-DC micro-converter having an MPPT control device structured to request that power output of each of the plurality of solar energy assemblies remains below a predefined threshold voltage;
placing outputs of each of the DC-DC micro-converters in electrical communication with a central converter, the central converter constructed to provide a central converter output power; and
configuring the central converter output power to be in electrical communication with a power grid.

19. The method of claim 18, wherein the placing includes coupling a power line between the voltage output of the separate DC-DC micro-converters to a junction box in electrical communication with the central converter.

20. The method of claim 19, which further includes coupling a power line between the central converter output power to the power grid.

21. The method of claim 20, wherein the central converter is a central DC-DC converter, and wherein the power grid is a low voltage direct current (LVDC) grid.

22. The method of claim 20, wherein the central converter is a DC-AC converter and the power grid is a 120/240 VAC grid.

23. The method of claim 18, which further includes coupling a battery to a DC bus of the plurality of solar energy assemblies.
